(19) United States
(12) Patent Application Publication
(10) Pub. No.: US 2026/0190203 A1
(43) Pub. Date: Jul. 2, 2026

(54) CONNECTED BULB RC LATCH OPTIMIZED FOR LOW STANDBY POWER

(71) Applicant: SIGNIFY HOLDING B.V., EINDHOVEN (NL)

(72) Inventors: HAIMIN TAO, EINDHOVEN (NL); BERTRAND JOHAN EDWARD HONTELE, BREDA (NL); GUY LOUIS PAUL DE BONDT, HERENTALS (NL); THEO GERRIT ZIJLMAN, TILBURG (NL); HENRICUS MARIUS JOSEPH MARIA KAHLMAN, DONGEN (NL); ANTENEH ALEMU ABBO, EINDHOVEN (NL)

(21) Appl. No.: 18/867,856

(22) PCT Filed: May 17, 2023
(86) PCT No.: PCT/EP2023/063383

§ 371 Date: Nov. 21, 2024

(30) Foreign Application Priority Data
May 24, 2022 (EP) 22175017.7

(51) Int. Cl. H05B 47/17; H05B 45/14; H05B 45/31; H05B 45/345; H05B 47/19

(52) U.S. Cl. CPC H05B 47/17; H05B 45/14; H05B 45/31; H05B 45/345; H05B 47/19

(57) ABSTRACT

The invention relates to a driver for driving a lighting load, the driver comprising a rectifier adapted to receive an alternating current, AC, input voltage and adapted to provide a rectified voltage, a converter adapted to convert the rectified voltage into an output voltage for the lighting load, a controller for controlling the converter and a switching element, and a latching circuit adapted to receive the alternating input voltage or the rectified voltage and comprising a series combination of a resistor, a capacitor and the switching element, wherein the controller is arranged to configure the converter in an active mode and a stand-by mode, close the switching element when the controller configures the converter in the active mode, and open the switching element when the controller configures the converter in the stand-by mode.

### FIELD OF THE INVENTION

The invention relates to a driver. The invention further relates to a lighting system. The invention further relates to a method.

### BACKGROUND OF THE INVENTION

The awareness on energy efficiency of lighting products has been increasing over time. Most of attention has been on the lamp efficiency on active mode. New regulations require the lamp to become more efficient. With proliferation of radio-wave wirelessly controlled LED lamps, standby power of wireless LED lamps gets more attention. Those lamps are controlled by a wireless switch, a sensor, or an app, and are connected to the mains voltage all the time. In a typical home, one may find dozens of such wireless lamps and therefore energy consumption of those lamps in standby mode can be rather significant since lamps will be in stand-by for a significant period of time during a day. A standby power of <0.5 W is required by the current legislation and thus this can mean a continuous standby power of several watts or even >10 W in a home. It is desired to provide a further reduction of standby power in the lamps to further reduce the energy consumption of lighting products.

### SUMMARY OF THE INVENTION

It is an objective of the invention to provide a driver that requires less power during standby operation.

In a first aspect of the invention, a driver for driving a lighting load is provided, which comprises:
a rectifier adapted to receive an alternating current, AC, input voltage and adapted to provide a rectified voltage;
a converter adapted to convert the rectified voltage into an output voltage for the lighting load;
a controller for controlling the converter and a switching element, and
a latching circuit adapted to receive the alternating input voltage or the rectified voltage and comprising a series combination of a resistor, a capacitor and the switching element,
wherein the controller is arranged to:
   configure the converter in an active mode and a stand-by mode;
   close the switching element when the controller configures the converter in the active mode, and
   open the switching element when the controller configures the converter in the stand-by mode.

A driver has a converter that converts an AC input voltage into a voltage that can be used by a lighting load. A rectifier rectifies an AC voltage into a rectified voltage. The driver has a latching circuit that can be used to improve the compatibility with a phase-cut dimmer. The latching circuit also has a series connection of a resistor, a capacitor and a switching element. The driver has a controller that is used to control the converter and the switching element. The controller may turn the converter in an active mode and a standby mode. In the active mode, the converter may provide a regulated power to the lighting load. In the stand-by mode, the converter may be inactive, i.e. no power is provided to the lighting load. The AC input voltage is provided by the phase-cut dimmer. The latching circuit provides an additional current when the phase-cut dimmer becomes active i.e., an additional current is drawn when the voltage to the driver rises at the phase-angle. This improves the compatibility of the driver with the phase-cut dimmer. The latching circuit however also provides additional losses. When the controller configures the converter in the standby mode, the latching circuit may also be disconnected. The controller therefore opens the switching element when the converter is set to the standby mode. The latching circuit will not be drawing any current and therefore, the latching circuit will not be dissipating any power. The phase-cut dimmer may at this moment not operate properly, but this is not relevant anymore because this operation is not visible for the user. When the converter is configured in the active mode, it is desired that the compatibility with the phase-cut dimmer is present, otherwise this may reflect in the light output of the lighting load, and the switching element is closed allowing the latching circuit to become active.

In a further example, the latching circuit is adapted to receive the alternating input voltage and wherein the latching circuit comprises a further rectifier, wherein the switching element is a semiconductor direct current, DC, switch and coupled at an output of the further rectifier and arranged to shunt the output of the further rectifier.

For an improved impact on the compatibility with the phase-cut dimmer, the latching circuit may be placed before the rectifier, and coupled to the AC input voltage. A further rectifier may be provided to provide a rectified voltage to the switching element. The switching element may then be a semiconductor that can only safely operate at a DC voltage, such as a MOSFET. The controller can provide a control signal to the switching element as the switching element is now placed in a DC operating regime and therefore does not require any adaptation for AC voltage operation. The switching element is then used to shunt the output of the further rectifier.

In a further example, the latching circuit is adapted to receive the alternating input voltage and wherein the switching element is a relay.

A relay provides a galvanic isolation between the control inputs and the switching inputs. The relay may be any type of relay such as e.g. an electromechanical relay or a solid state relay. A further rectifier is in this situation not required and the controller can directly provide a control signal to the control inputs.

In a further example, the driver comprises an auxiliary power supply for powering the controller.

Preferably, an auxiliary power supply is provided for powering the controller. When the converter is in standby, it may still be desired to keep the controller powered. This allows the controller to e.g. receive and process information that may be used to configure the converter in the active mode. The auxiliary power supply may only need to provide a small amount of power to the controller compared to the power that needs to be provided to the lighting load. In addition, in the standby mode, the phase-cut dimmer may not operate properly but this has no impact on the power supply to the controller.

In a further example, an input of the auxiliary power supply is coupled to the switching element, wherein the auxiliary power supply is arranged to provide a conductive path for a current to flow through the resistor and capacitor when the switching element is open.

The auxiliary power supply may receive its power via the resistor and capacitor of the latching circuit. Therefore, the switching element needs to be opened so that the auxiliary power supply can provide a conductive path for a current to flow through at least the capacitor. This current is then used by the auxiliary power supply to provide an auxiliary output voltage that may for example be used by the controller. The auxiliary power supply provides the conductive path when the switching element is open.

In a further example, the driver comprises a phase-cut dimmer detection circuit adapted to detect a presence of a phase-cut in the AC input voltage.

It may be desired to detect the presence of a phase-cut dimmer. This may allow for further functionalities to be implemented such as e.g. allow phase-cut dimming or determining the type of phase-cut dimmer.

In a further example, the controller is further arranged to close the switching element in the active mode when the phase-cut dimmer detection circuit detects a phase-cut in the AC input voltage.

To reduce power losses during operation of the driver and when the converter is active, the switching element may be closed upon a detection of a phase-cut dimmer and when the controller has configured the converter in the active mode. When no phase-cut dimmer is detected, the latching circuit may not be needed. It is therefore desired to close the switch only when a phase-cut dimmer has been detected and when the converter is active.

In a further example, the controller is arranged to receive wireless control commands for controlling the converter. The controller may receive control commands for controlling the converter and therefore also the light generated by the lighting load. Preferably, the control commands are sent wirelessly, which provides an easy communication between a remote control device e.g. a mobile phone or remote controller. When the converter is in standby, the controller may still receive the wireless control commands.

In a further example, the converter is a switched mode power supply.

The converter may be a switched mode power supply (SMPS), which can easily be configured in the active mode and the standby mode. Additionally, an SMPS is very energy efficient and therefore desired to be used in lighting applications.

In a further example, the auxiliary power supply is a switched mode power supply.

Similar to the converter, it is desired to have the auxiliary power supply to be an SMPS. Because the auxiliary power supply only needs to provide a relative low amount of power compared to the converter, the auxiliary power supply can be relatively small.

In another example, a lighting system comprising the driver according to the invention and the lighting load.

Preferably, the driver is part of a lighting system. The energy efficiency of the entire lighting system is improved with the introduced driver.

In another example, the lighting load is a solid-state lighting load.

A solid-state lighting load requires a low amount of power compared to conventional lighting loads. A reduction of power consumption of the driver already has a significant impact on the total power consumption of the lighting system. The solid-state lighting load may for example be any of an LED, a laser diode or a vertical-cavity surface-emitting laser, VCSEL.

In another example, a method for controlling a driver comprising:
a converter adapted to convert a rectified voltage into an output voltage for a lighting load;
a controller for controlling the converter and a switching element, and
a latching circuit adapted to receive the alternating input voltage or the rectified voltage and comprising a series combination of a resistor, a capacitor and the switching element,
the method comprising the steps of:
   configuring the converter in an active mode;
   configuring the converter in a stand-by mode;
   closing the switching element when the converter is in the active mode, or closing the switching element when the converter is in the active mode and when the phase-cut has been detected, and
   opening the switching element when the converter is in the stand-by mode.

The method allows the driver according to the invention to be controlled by configuring the converter in the active mode and standby mode. The switching element is closed when the converter is in the active mode and the switching element is opened when the converter is in the standby mode.

### BRIEF DESCRIPTION OF THE DRAWINGS

Examples of the invention will now be described with reference to the accompanying drawings, in which:

FIG. 1 shows an example of a driver according to the state of the art.

FIG. 2 shows another example of a driver according to the state of the art.

FIG. 3 shows an example of a driver according to the invention.

FIG. 4 shows another example of a driver according to the invention.

FIG. 5 shows another example of a driver according to the invention.

FIG. 6 shows a further example of a driver according to the invention.

FIG. 7 shows a flow diagram for controlling the driver according to the invention.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

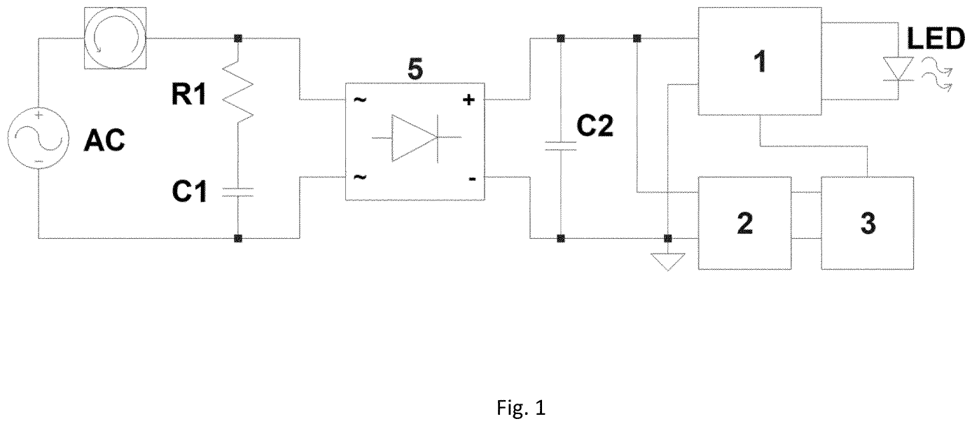

FIG. 1 shows a drive that is known form the state of the art. The driver is coupled to a phase-cut dimmer that provides a phase-cut in the mains voltage. A rectifier 5 is used to rectify the AC input voltage and provide a rectified voltage between the outputs of the rectifier 5. The rectified voltage is provided to a converter 1. The converter 1 converts the rectified voltage to an output voltage that is coupled to a lighting load LED. A controller 3 is provided to control the converter 1. The controller 3 may configure the converter 1 in an active mode and a standby mode. A latching circuit is used to improve the compatibility between the driver and the phase-cut dimmer. When the phase-cut dimmer is active, a steep rise in the input voltage occurs. This is the rising edge of the input voltage. At this moment, the triac in the phase-cut dimmer is closed. For the triac to close properly, a large current is needed at the moment that the triac closes, also known as the latching current. If the current is too low, the triac may open again, and no voltage is provided to the driver and this may result in an unstable output power. The latching circuit has a series combination of the resistor R1 and capacitor C1 that draws a current that is at its highest the moment the triac turns on. This additional current allows the triac to start up properly. When the converter 1 is in the standby mode, the latching circuit remains active and therefore also power will be lost in the latching circuit.

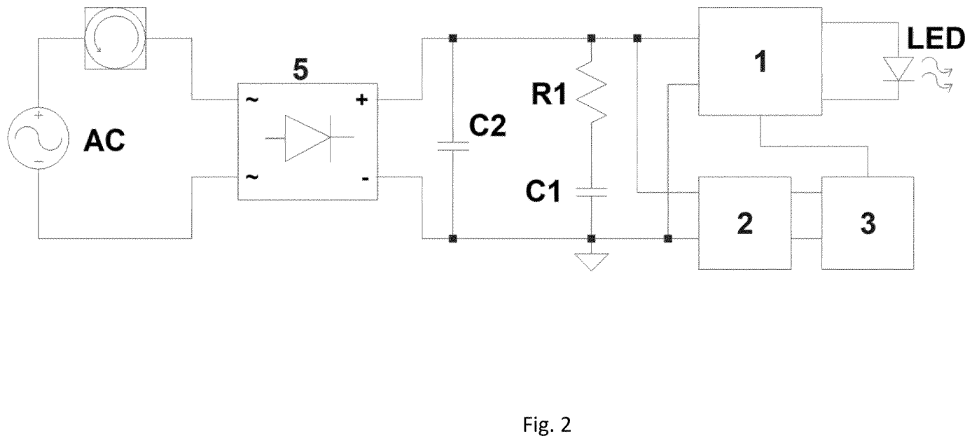

FIG. 2 shows another example of a driver as is known in the state of the art. The basic structure of the driver is similar to that of the driver of FIG. 1. The latching circuit is now placed after the rectifier 5 and coupled to the rectified voltage. The latching circuit still fulfils the same functionality, however it is less effective in providing latching and holding current for the triac dimmer.

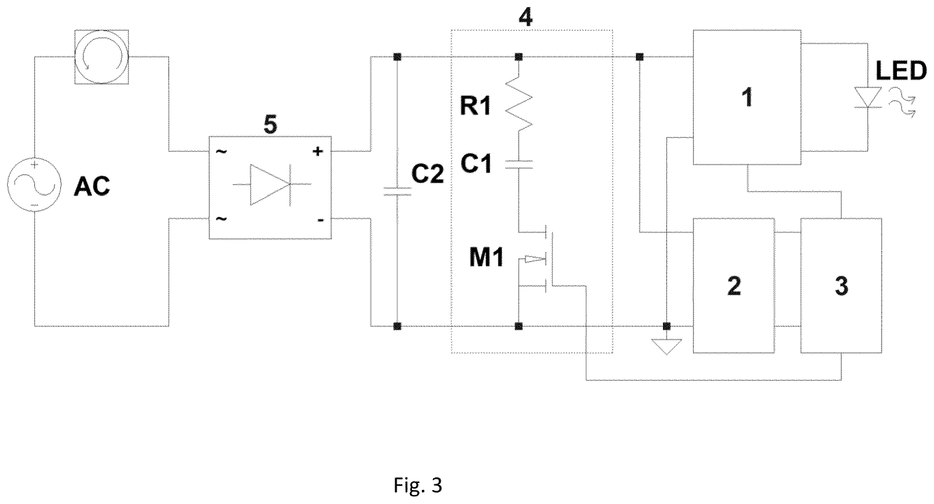

FIG. 3 shows an example of a driver according to the invention. The driver has a rectifier 5 that rectifies an AC input voltage and provides a rectified voltage at the output of the rectifier 5. The rectified voltage is provided to a converter 1. The converter converts the rectified voltage into an output voltage that is provided to a lighting load LED. A controller 3 is used to control the converter 1. The controller 3 is arranged to configure the converter 1 in an active mode and a standby mode. When the converter 1 is in the active mode, the output voltage may be provided to the lighting load LED such that the lighting load LED is powered. When the converter 1 is in the standby mode, the converter 1 may not provide an output voltage to the lighting load LED, thereby preventing the lighting load LED from emitting any light. In the example provided, the latching circuit 4 has a series combination of a resistor R1, a capacitor C1 and a switching element M1. The latching circuit 4 is placed at the output of the rectifier 5 and receives the rectified voltage. The controller 3 provides a control signal to the switching element M1. When the converter 1 is configured in the active mode, the controller 3 provides a control signal for closing the switching element M1. When the converter 1 is active, the latching circuit is also active. As long as the phase-cut dimmer operates properly, the converter 1 can provide a properly regulated output voltage for the lighting load LED. When the converter 1 is in standby, the controller 3 provides a control signal to the switching element M1 for opening the switching element M1. When the converter 1 is not active, e.g. in standby, the compatibility with the phase-cut dimmer is not relevant anymore. The latching circuit 4 is therefore disconnected by opening the switching element M1 such that no current can flow through the resistor R1 and capacitor C1. There will be no power losses in the latching circuit 4 during the standby of the converter 1. The placement of the latching circuit 4 in the DC path, coupled to the rectified voltage, has the benefit that the switching element M1 can be controlled easily. The control signal provided by the controller 3 can be directly coupled to the switching element M1. The switching element can be in this example any type of switching element that can be controlled with an electric signal. Examples of such a switching element M1 may be a semiconductor switch such as a MOSFET, IGBT or a bipolar transistor.

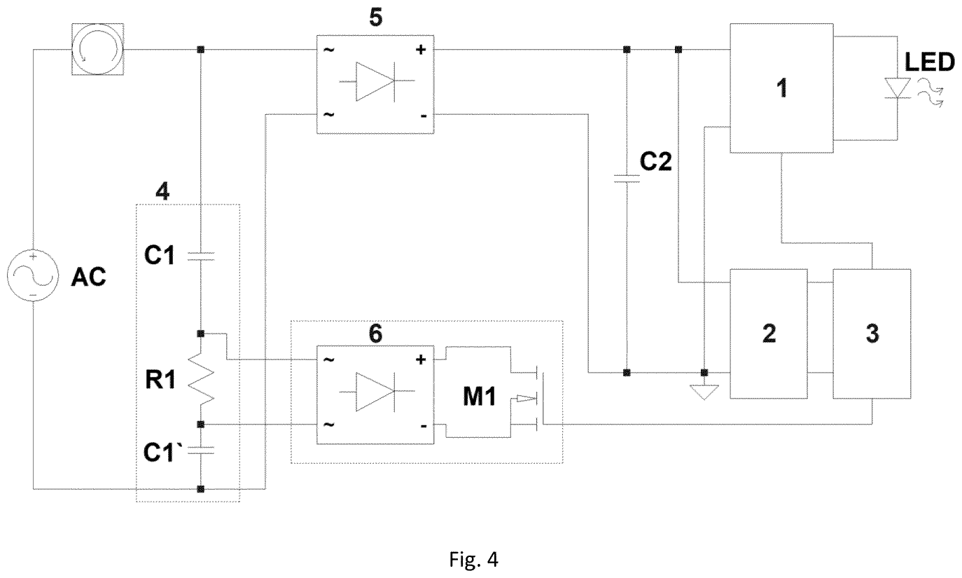

FIG. 4 shows another example of a driver. The driver has similar features as the driver of FIG. 3. The latching circuit 4 is now placed before the rectifier 5 and is coupled to the AC input voltage. The resistor R1 and capacitor C1 may be identical to the resistor and capacitor as shown in FIG. 3. However, for proper function of the circuit, the capacitor C1 needs to be split into two parts, C1 and C1′, as shown in FIG. 4. This is due to the fact that the rectifier 5 and the further rectifier 6 share the same ground. The capacitor C1′ prevent a DC path which could result in a high current due to phase difference between the two rectifiers. The switching element M1 is coupled to the resistor R1 and capacitor C1, C1′ via a further rectifier 6. The further rectifier provides another rectified voltage at its outputs. The switching element M1 is coupled across the outputs of the further rectifier 6 such that the output of the further rectifier 6 is shunted when the switching element M1 is closed. The use of the further rectifier 6 allows the switching element 6 to be controlled similar as the switching element M1 as shown in FIG. 3. The controller 3 can provide a control signal to the switching element M1.

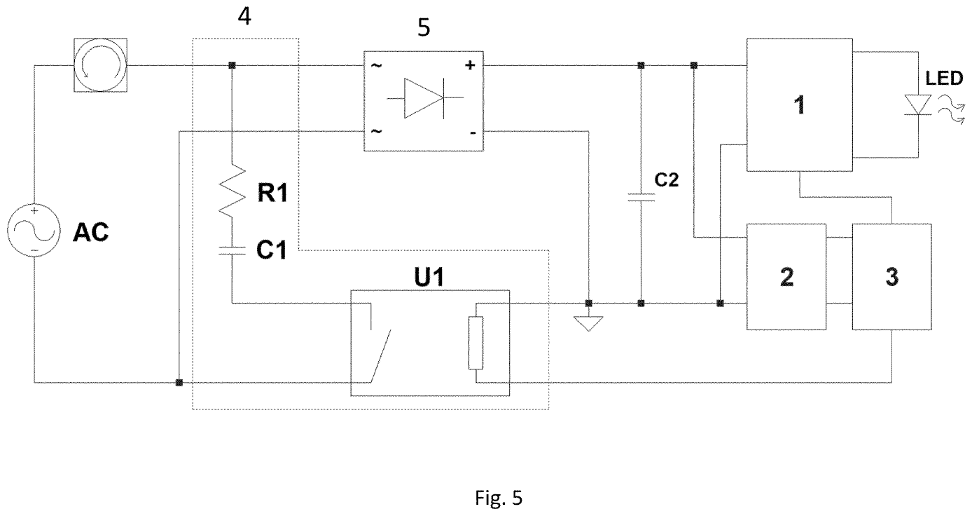

FIG. 5 shows another example of a driver. The driver has similar features as the drivers of FIGS. 3 and 4. The latching circuit 4 is now placed before the rectifier 5 and is coupled to the AC input voltage. The resistor R1 and capacitor C1 may be identical to the resistor and capacitor as shown in FIGS. 3 and 4. The switching element U1 is a relay that has an input for a relay control signal and a relay switching element that can be opened and closed based on the relay control signal. The input for the relay control signal is galvanically isolated from the relay switching element. This allows the relay switching element to be directly coupled to the resistor R1 and capacitor C1. The input for the relay control signal may be directly coupled to the controller 3 and receive the control signal. The relay may behave similarly to the switching elements shown in FIGS. 3 and 4. When the relay switching element is closed, the latching circuit 4 is operational. When the relay switching element is opened, the latching circuit 4 is not operational. Examples of relays are electro-mechanic relays and solid-state relays.

In the examples provided, an auxiliary power supply 2 may be provided to provide power to the controller 3. The auxiliary power supply 2 may remain active when the converter 1 is in the standby mode. This allows the controller 3 to remain powered even when the converter 1 is in standby. The controller 3 may then still send and receive information that may be used for controlling the driver.

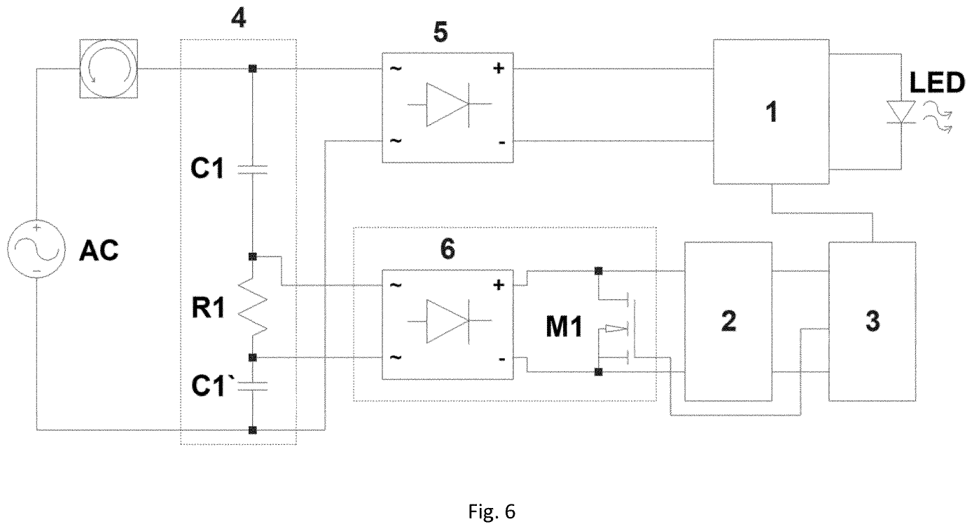

In FIG. 6, an example of a driver is provided where the auxiliary power supply 2 is coupled to the switching element M1. The switching element M1 is connected similar to the switching element shown in FIG. 4. The switching element M1 is coupled to the resistor R1, capacitor C1 and capacitor C1′ via a further rectifier 6. The further rectifier provides another rectified voltage at its outputs. The switching element M1 is coupled across the outputs of the further rectifier 6 such that the output of the further rectifier 6 is shunted when the switching element M1 is closed. The use of the further rectifier 6 allows the switching element 6 to be controlled similar as the switching element M1 as shown in FIG. 3. The controller 3 can provide a control signal to the switching element M1. The auxiliary power supply 2 is coupled across the switching element M1. This means that the switching element M1 also shunts the input of the auxiliary power supply 2 when the switching element M1 is closed. When the switching element M1 is open, the converter 1 is in standby mode and the voltage across the switching element M1 is provided to the auxiliary power supply 2. The latching circuit 4 may in this example, when the converter 1 is in standby mode, fulfil a different function namely providing a low power path for the auxiliary power supply 2. When the converter 1 is active and the switching element M1 is closed, the auxiliary power supply 2 may be powered via another power source. The converter 1 may provide power to the auxiliary power supply 2, e.g. via an auxiliary winding of a transformer/inductor of the converter 1. Alternatively, when the converter 1 is active, the switching element M1 may be opened and the auxiliary power supply 2 may then receive the current coming from the resistor R1 and capacitor C1 such that the latching circuit 4 remains operational during the active mode of the converter 1. The switching element M1 combined with the circuitry in the auxiliary power supply 2 allowing the latching circuit 4 to be active may then be considered the switching element M1 according to the invention that performs the closing and opening based on a control signal from the controller 3.

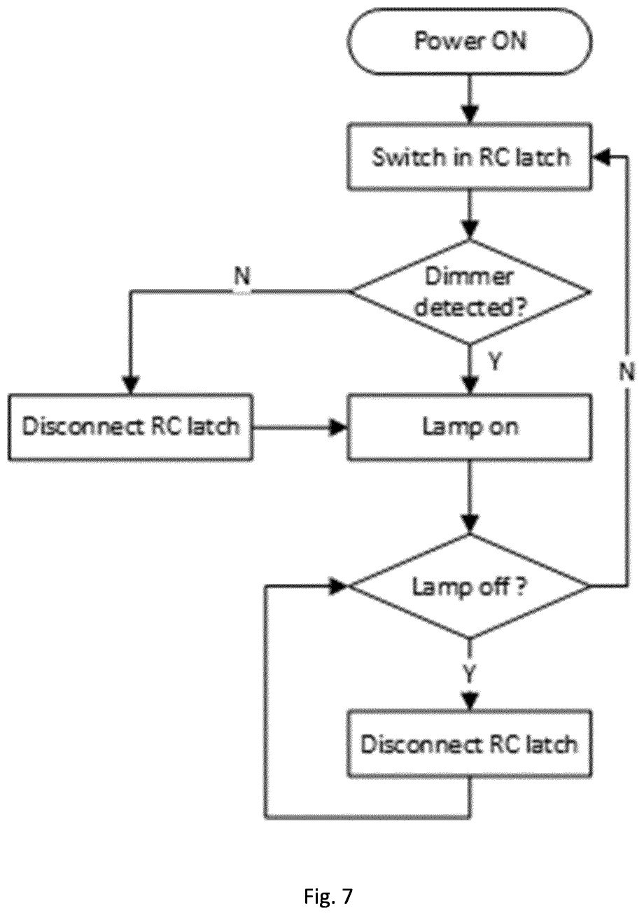

FIG. 7 shows a method for controlling the driver according to the invention. The driver may be any of the drivers as shown and described in FIGS. 3, 4, 5 and 6. The method comprises the step of turning on the driver at a start-up moment. This may for example be when the input voltage is provided for a first time. At, or directly after, turning on the driver, the latching circuit 4 is turned on. This is done by closing the switching element M1. After the activating of the latching circuit 4, lamp is turned on by turning on the converter 1 and a power is provided to the lighting load LED such that a light will be generated. When the lighting load LED is turned off, i.e. the converter 1 is configured in the standby mode, the latching circuit 4 is disconnected by opening the switching element M1. Furthermore, the circuit detects if a dimmer is present. As long as the lighting load LED is not turned off and a dimmer is detected, the latching circuit 4 remains active i.e. the switching element M1 remains closed.

The driver is preferably used in a lighting system. The lighting system comprises the driver and the lighting load LED. Preferably, the lighting load LED is a solid-state lighting load.

The lighting system may be connected to a phase-cut dimmer. In the examples provided, the lighting system is required to be compatible with the phase-cut dimmer, which means that during operation of the lighting load LED, the phase-cut dimmer needs to operate properly and preferably without any disturbances. The driver provides the latching circuit 4 that is active when the converter 1 is active and the lighting load LED is powered. When the lighting system goes into standby, the converter 1 is in standby and the lighting load LED is turned off. The latching circuit 4 is then also turned off so that the standby power of the lighting system is kept as low as possible.

In the examples provided, the auxiliary power supply 2 and/or the converter 1 may be a switched mode power supply. Examples of switched mode power supplies are: boost converter, buck converter, buck-boost converter, flyback converter and an LLC converter.

In the examples provided, the driver may also have a phase-cut dimmer detection circuit. The phase-cut dimmer detection circuit may detect a phase-cut in the AC input voltage. This detection may be used to close the switching element M1 further based on the detection of a phase-cut dimmer. To provide a more energy efficient driver when no phase-cut dimmer is present, the driver does not need an active latching circuit 4 when the converter 1 is active. therefore, the switching element M1 is only closed when the converter 1 is active and when the phase-cut dimmer has been detected.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A driver for driving a lighting load the driver comprising:
a rectifier adapted to receive an alternating current, AC, input voltage and adapted to provide a rectified voltage;
a converter adapted to convert the rectified voltage into an output voltage for the lighting load;
a controller arranged to control the converter and a switching element, and
a latching circuit adapted to receive the alternating input voltage or the rectified voltage and comprising a series combination of a resistor, a capacitor and the switching element,
wherein the controller is arranged to:
configure the converter in an active mode and a stand-by mode;
close the switching element when the controller configures the converter in the active mode, and
open the switching element when the controller configures the converter in the stand-by mode.

2. The driver according to claim 1, wherein the latching circuit is adapted to receive the alternating input voltage and wherein the latching circuit comprises a further rectifier, wherein the switching element is a semiconductor direct current, DC, switch and coupled at an output of the further rectifier and arranged to shunt the output of the further rectifier, wherein the capacitor C1 is arranged as two separate capacitors, each connected to one of the input terminals of the further rectifier.

3. The driver according to claim 1, wherein the latching circuit is adapted to receive the alternating input voltage and wherein the switching element is a relay.

4. The driver according to claim 1, further comprising an auxiliary power supply for powering the controller.

5. The driver according to claim 4, wherein an input of the auxiliary power supply is coupled to the switching element, wherein the auxiliary power supply is arranged to provide a conductive path for a current to flow through the capacitor when the switching element is open.

6. The driver according to claim 1, further comprising a phase-cut dimmer detection circuit adapted to detect a presence of a phase-cut in the AC input voltage.

7. The driver according to claim 6, wherein the controller is further arranged to close the switching element in the active mode when the phase-cut dimmer detection circuit detects a phase-cut in the AC input voltage.

8. The driver according to claim 1, wherein the controller is arranged to receive wireless control commands for controlling the converter.

9. The driver according to claim 1, wherein the converter is a switched mode power supply.

10. The driver according to claim 4, wherein the auxiliary power supply is a switched mode power supply.

11. A lighting system comprising the driver according to claim 1 and the lighting load.

12. The lighting system according to claim 11, wherein the lighting load is a solid-state lighting load.

13. A method for controlling a driver comprising:
a converter adapted to convert a rectified voltage into an output voltage for a lighting load;
a controller for controlling the converter and a switching element, and
a latching circuit adapted to receive the alternating input voltage or the rectified voltage and comprising a series combination of a resistor, a capacitor and the switching element,
the method comprising:
configuring the converter in an active mode;
configuring the converter in a stand-by mode;
closing the switching element when the converter is in the active mode, or closing the switching element when the converter is in the active mode and when the phase-cut has been detected, and
opening the switching element when the converter is in the stand-by mode.
